(19) United States
(12) Patent Application Publication
(10) Pub. No.: US 2024/0376936 A1
(43) Pub. Date: Nov. 14, 2024

(54) PRESS TOOL ASSEMBLIES, SYSTEMS, AND METHODS FOR INSERTING BUSHING ASSEMBLIES

(71) Applicant: Tiger Tool International Incorporated, Abbotsford (CA)

(72) Inventor: Michael Andrews, Bellingham, WA (US)

(73) Assignee: Tiger Tool International Incorporated, Abbotsford, BC (CA)

(21) Appl. No.: 18/642,359

(22) Filed: Apr. 22, 2024

Related U.S. Application Data
(60) Provisional application No. 63/497,987, filed on Apr. 24, 2023.

(51) Int. Cl. F16C 43/02

(52) U.S. Cl. CPC F16C 43/02; F16C 2226/12

(57) ABSTRACT

A press tool system for pressing a bushing assembly into a bushing opening defined by a structural member comprising a tool assembly and an actuator system. The press tool system comprises a tool assembly and an actuator system. The tool assembly comprises a brace assembly, a drive member, and a retaining sleeve. The actuator system comprises an actuator housing assembly and a piston member. The brace assembly is arranged to brace the actuator housing assembly relative to the structural member. The drive member is arranged between the piston member and the bushing assembly. The retaining sleeve is arranged at least partly around the bushing assembly. The actuator system displaces the piston member relative to the actuator housing assembly to force the bushing assembly at least partly through the retaining sleeve and into the bushing opening in a desired position relative to the structural member.

### RELATED APPLICATIONS

This application (Attorney's Ref. No. P220503) claims benefit of U.S. Provisional Application Ser. No. 63/497,987 filed Apr. 24, 2023, the contents of which are incorporated herein by reference.

### TECHNICAL FIELD

The present invention relates to press tools for inserting bushing assemblies and, more particularly, to press tools for inserting bushing assemblies having non-metal bushing housings.

### BACKGROUND

Bushings form an energy absorbing interface between two metal objects. The bushing is typically made of a flexible material such as rubber, synthetic rubber, polyurethane, or the like. A typical bushing takes the form of a bushing assembly comprising a bushing housing and a bushing member arranged within the bushing housing.

As one example, in a vehicle suspension system, bushing assemblies are often used to attach a leaf spring to the chassis of the vehicle. The leaf spring defines a bushing opening, and the bushing assembly is driven or pressed in to the bushing opening using a press tool. The present invention is of particular relevance when used to assemble a bushing into an opening in a leaf spring, and that application of the present invention will be described herein. However, the press tool of the present invention may be used to insert bushings in other operating environments.

When the bushing housing is made of metal, the bushing assembly can be driven into the opening in the part that supports the bushing by applying a driving or pressing force to the bushing housing, which in turn carries the bushing member into the opening. However, a class of bushing assemblies employs a non-metal bushing housing. The use of a press to drive or press a non-metal bushing housing can result in a cracked or deformed bushing housing that may comprise the functionality of the bushing assembly. Special factory press systems and methods are used at the factory to install bushing assemblies having non-metal bushing housings. However, the use of such special press systems and methods is not feasible in a non-factory repair or maintenance shop environment.

The need thus exists for improved press tool assemblies, systems, and methods that can be used in repair or maintenance shop environments.

### SUMMARY

The present invention may be embodied as a press tool system for pressing a bushing assembly into a bushing opening defined by a structural member comprising a tool assembly and an actuator system. The press tool system comprises a tool assembly and an actuator system. The tool assembly comprises a brace assembly, a drive member, and a retaining sleeve. The actuator system comprises an actuator housing assembly and a piston member. The brace assembly is arranged to brace the actuator housing assembly relative to the structural member. The drive member is arranged between the piston member and the bushing assembly. The retaining sleeve is arranged at least partly around the bushing assembly. The actuator system displaces the piston member relative to the actuator housing assembly to force the bushing assembly at least partly through the retaining sleeve and into the bushing opening in a desired position relative to the structural member.

The present invention may also be embodied as a method of pressing a bushing assembly into a bushing opening defined by a structural member, the method comprising the following steps. A tool assembly comprising a brace assembly, a drive member, and a retaining sleeve is provided. An actuator system comprising an actuator housing assembly and a piston member is provided. The brace assembly is arranged to brace the actuator housing assembly relative to the structural member. The drive member is arranged between the piston member and the bushing assembly. The retaining sleeve is arranged at least partly around the bushing assembly. The actuator system is operated to displace the piston member relative to the actuator housing assembly to force the bushing assembly at least partly through the retaining sleeve and into the bushing opening in a desired position relative to the structural member.

The present invention may also be embodied as a press tool system for pressing a bushing assembly into a bushing opening defined by a structural member. The press tool system comprises a tool assembly and an actuator system. The tool assembly comprises a brace assembly, a drive member, and a retaining sleeve. The actuator system comprises an actuator housing assembly and a piston member. The brace assembly is arranged to brace the actuator housing assembly relative to the structural member. The drive member is arranged between the piston member and the bushing assembly. The retaining sleeve is arranged at least partly around the bushing assembly. The retaining sleeve is arranged and configured to engage the structural member as the bushing assembly is forced into the bushing opening. The actuator system displaces the piston member relative to the actuator housing assembly to force the bushing assembly at least partly through the retaining sleeve and into the bushing opening in a desired position relative to the structural member.

### BRIEF DESCRIPTION OF THE DRAWINGS

FIG. 1 is a perspective view illustrating the use of a first example press tool assembly and system of the present invention to insert a bushing assembly into a bushing opening in a leaf spring;

FIG. 2 is a side elevation exploded view of the first example press tool assembly and system, the bushing assembly to be inserted therewith, and a portion of the leaf spring defining the bushing opening;

FIG. 3 is a side elevation view of the example first example press tool assembly and system, the bushing assembly to be inserted therewith, and a portion of the leaf spring defining the bushing opening;

FIG. 4 is a side elevation partial section view of the example first example press tool assembly and system, the bushing assembly to be inserted therewith, and a portion of the leaf spring defining the bushing opening;

FIGS. 5 and 6 are side elevation section views depicting use the example first example press tool assembly and system to insert the bushing assembly in to the bushing opening; and

FIG. 7 is a side elevation section view illustrating the bushing assembly as installed in the bushing opening in the leaf spring.

### DETAILED DESCRIPTION

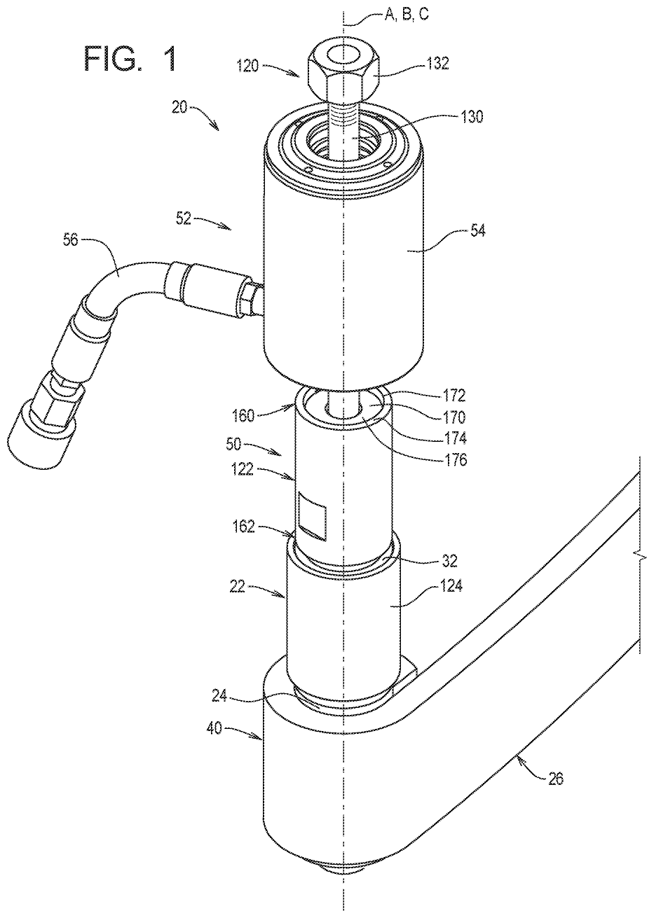

Referring initially to FIG. 1 of the drawing, depicted therein is a press tool system 20 configured to press a bushing assembly 22 into a bushing opening 24 formed in a structural member 26. The example structural member 26 is a leaf spring, but the present invention can be used with any structural member defining a bushing opening. The example bushing assembly 22 comprises a bushing member 30 coaxially mounted within a bushing housing 32. As is conventional, the example bushing member 30 defines a bushing passageway 34. The example structural member 26 defines a bushing support portion 40 defining the bushing opening 24. The example bushing assembly 22 and structural member 26 are or may be conventional and will be described herein only to that extent necessary for a complete understanding of the present invention.

The example press tool system 20 comprises a tool assembly 50 and an actuator system 52 comprising an actuator assembly 54 and a fluid supply line 56 connected to a fluid source (not shown). The example actuator assembly 54 comprises an actuator housing assembly 60 and a piston member 62. An actuator passageway 64 extends through the actuator housing assembly 60 and the piston member 62. Introduction of pressurized fluid from the fluid source through the fluid supply line 56 and into the actuator housing assembly 60 causes displacement of the piston member 62 relative to the actuator housing assembly 60.

The example tool assembly 50 comprises a brace assembly 120, a drive member 122, and a retaining sleeve 124. The drive member 122 is arranged to engage the piston member 62, the bushing assembly 22 is arranged within the retaining sleeve, and the retaining sleeve 124 is arranged between the drive member 122 and the bushing support portion 40. Operation of the actuator system 52 applies a drive or press force on the bushing assembly 22 through the drive member 122 and the retaining sleeve 124 such that the bushing assembly 22 is driven into the bushing opening 24.

The example brace assembly 120 comprises a brace rod 130, a brace nut 132, and an anchor nut 134. The example brace rod 130 defines a first threaded portion 140, a shaft portion 142, and a second threaded portion 144. The example anchor nut 134 defines a main portion 150, a flange portion 152, and an anchor passageway 154 defining a threaded portion 156 and a bushing portion 158.

The example drive member 122 defines an actuator end 160 and a drive end 162. The example actuator end 160 defines a piston engaging surface 170, and a spacing projection 172 extends from the example piston engaging surface 170 to define a housing engaging surface 174 and a piston cavity 176. The example drive end 162 defines a drive engaging surface 180, a drive projection 182. The drive engaging surface 180 and the drive projection 182 define a drive cavity 184.

The example retaining sleeve 124 defines a first end 190, a second end 192, and a drive interior surface 194 defining a sleeve passageway 196.

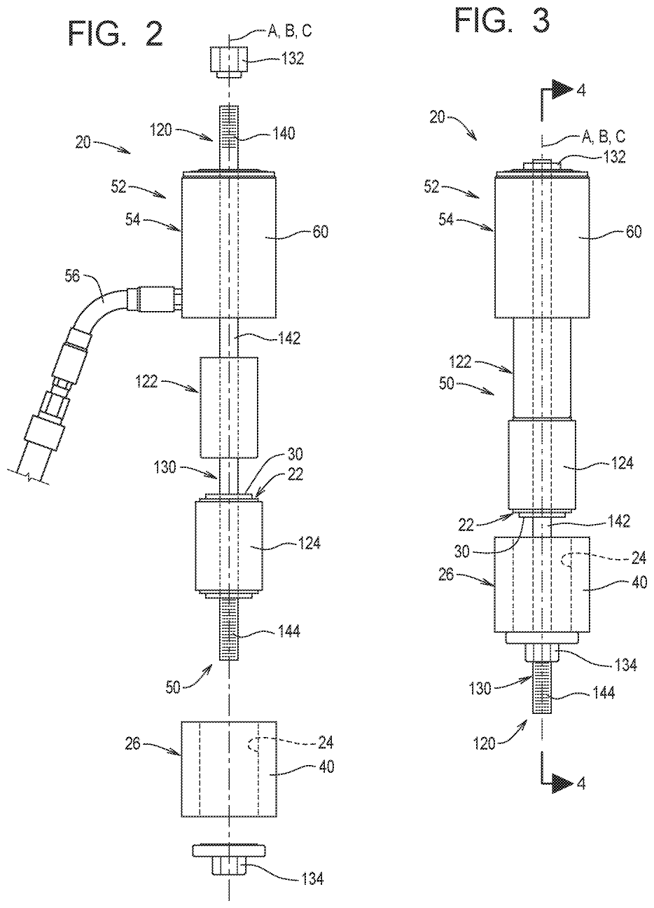

The example press tool system 20 defines a press axis A, the example bushing assembly 22 defines a bushing axis B, and the example bushing opening 24 defines a structural axis C. With the press axis A, the bushing axis B, and the structural axis C substantially aligned as shown in FIG. 2, at least a portion of the example brace rod 130 is passed through the actuator passageway 64, the drive cavity 164, the sleeve passageway 196, the bushing passageway 34, and the anchor passageway 154.

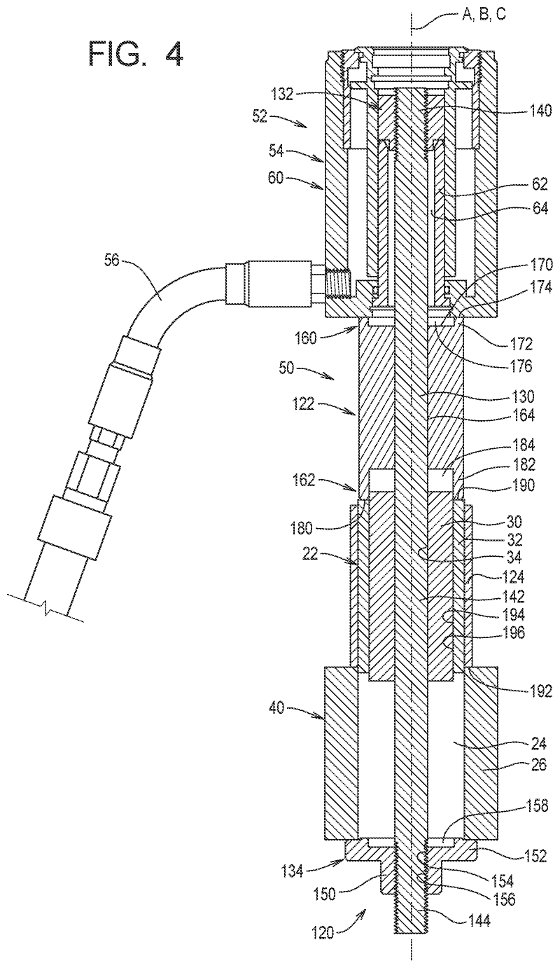

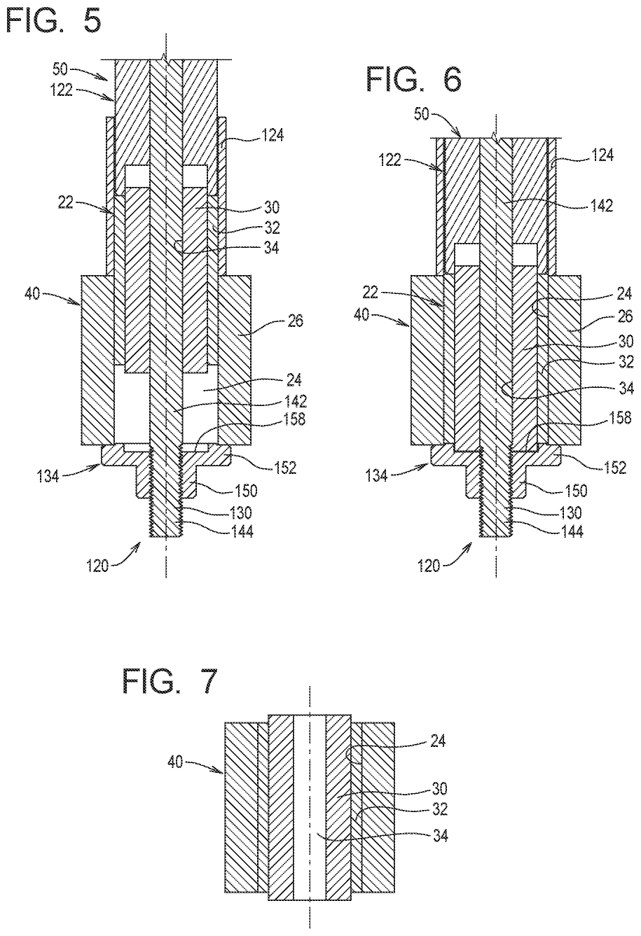

The brace nut 132 is secured to the first threaded portion 140 of the brace rod 130, and the anchor nut 134 is secured to the second threaded portion 144 of the brace rod 130. With the piston member 62 in a retracted position, the brace nut 132 and the anchor nut 134 are tightened such that the brace nut 132 engages the actuator housing assembly 60 and the flange portion 152 of the anchor nut 134 engages the structural member 26. As shown in FIGS. 3 and 4, the press axis A, the bushing axis B, and the structural axis C are all substantially aligned, and a distance between the brace nut 132 and the anchor nut 134 is substantially fixed.

Operation of the actuator system 52 displaces the piston member 62 relative to the actuator housing assembly 54 towards the structural member 26. Displacement of the piston member 62 displaces the drive member 122 towards the retaining sleeve 124 towards the structural member 26. Displacement of the drive member 122 displaces the bushing assembly 22 into the bushing opening 24.

During driving of the bushing assembly 22 into the bushing opening 24, the piston member 62 engages the piston engaging surface 170 of the drive member 122, the drive engaging surface 180 engages bushing housing 32, and the bushing housing 32 is completely surrounded by the retaining sleeve 124. The tolerances between the sleeve passageway 196 and an exterior surface of the bushing housing 32 are such that the bushing assembly 22 to be displaced through the retaining sleeve 124 but deformation or cracking of the bushing housing 32 during driving of the bushing assembly 22 is substantially prevented.

The actuator system 52 is operated until at least a portion of the bushing assembly 22 is within the bushing portion 158 of the anchor passageway 154. The example anchor bushing portion 158 is configured such that, when at least a portion of the bushing assembly 22 engages the anchor nut 134, the bushing assembly 22 is in a desired position relative to the structural member 26.

Disconnecting the source of pressurized fluid from the actuator system 52 and releasing pressurized fluid from the actuator assembly 54 removes the driving of pressing force from the bushing assembly 22. When the pressurized fluid is released, the brace and/or anchor nuts 132 and 134 may be removed from the brace rod 130 as shown in FIG. 7 allows the example tool assembly 50 to be disassembled and removed from the bushing assembly 22, leaving the bushing assembly 22 securely supported within the bushing opening 24 defined by the structural member 26.

What is claimed is:

1. A press tool system for pressing a bushing assembly into a bushing opening defined by a structural member, the press tool system comprising:
a tool assembly comprising a brace assembly, a drive member, and a retaining sleeve; and
an actuator system comprising an actuator housing assembly and a piston member; wherein
the brace assembly is arranged to brace the actuator housing assembly relative to the structural member;
the drive member is arranged between the piston member and the bushing assembly;
the retaining sleeve is arranged at least partly around the bushing assembly; and
the actuator system displaces the piston member relative to the actuator housing assembly to force the bushing assembly at least partly through the retaining sleeve and into the bushing opening in a desired position relative to the structural member.

2. A press tool as recited in claim 1, in which the retaining sleeve is arranged and configured to engage the structural member as the bushing assembly is forced into the bushing opening.

3. A press tool as recited in claim 1, in which the bushing assembly moves relative to the retaining sleeve as the bushing assembly is forced into the bushing opening.

4. A press tool as recited in claim 1, in which the drive member is arranged and configured to extend at least partly into the retaining sleeve as the bushing assembly is forced into the bushing opening.

5. A press tool as recited in claim 1, in which the brace assembly comprises a brace rod configured to extend through the drive member, the bushing assembly, the retaining sleeve, and the bushing opening.

6. A press tool as recited in claim 1, in which the brace assembly comprises an anchor nut configured to engage the structural member such that the brace assembly is arranged and configured to limit movement of the actuator housing assembly relative to the structural member.

7. A press tool as recited in claim 1, in which the brace assembly comprises a brace nut configured to engage the actuator housing assembly such that the brace assembly is arranged and configured to limit movement of the actuator housing assembly relative to the structural member.

8. A press tool as recited in claim 1, in which the brace assembly comprises:
a brace rod configured to extend through the drive member, the bushing assembly, the retaining sleeve, and the bushing opening;
an anchor nut configured to engage brace rod and the structural member; and
a brace nut configured to engage brace rod and the actuator housing assembly such that the brace assembly maintains a maximum distance between the actuator housing assembly and the structural member; whereby
the brace assembly is arranged and configured to limit movement of the actuator housing assembly relative to the structural member.

9. A method of pressing a bushing assembly into a bushing opening defined by a structural member, the method comprising the steps of:
providing a tool assembly comprising a brace assembly, a drive member, and a retaining sleeve;
providing an actuator system comprising an actuator housing assembly and a piston member;
arranging the brace assembly to brace the actuator housing assembly relative to the structural member;
arranging the drive member between the piston member and the bushing assembly;
arranging the retaining sleeve at least partly around the bushing assembly; and
operating the actuator system to displace the piston member relative to the actuator housing assembly to force the bushing assembly at least partly through the retaining sleeve and into the bushing opening in a desired position relative to the structural member.

10. A method as recited in claim 9, further comprising the step of arranging and configuring the retaining sleeve to engage the structural member as the bushing assembly is forced into the bushing opening.

11. A method as recited in claim 9, in which the bushing assembly moves relative to the retaining sleeve as the bushing assembly is forced into the bushing opening.

12. A method as recited in claim 9, further comprising the step of arranging and configuring the drive member to extend at least partly into the retaining sleeve as the bushing assembly is forced into the bushing opening.

13. A method as recited in claim 9, in which the step of providing brace assembly comprises the steps of:
providing a brace rod configured to extend through the drive member, the bushing assembly, the retaining sleeve, and the bushing opening; and
arranging the brace rod to extend through the drive member, the bushing assembly, the retaining sleeve, and the bushing opening.

14. A method as recited in claim 9, in which the step of providing the brace assembly comprises the steps of:
providing an anchor nut configured to engage the structural member; and
arranging the anchor nut such that the brace assembly limits movement of the actuator housing assembly relative to the structural member.

15. A method as recited in claim 9, in which the step of providing the brace assembly comprises the steps of:
providing a brace nut configured to engage the actuator housing assembly; and
arranging the brace nut such that the brace assembly limits movement of the actuator housing assembly relative to the structural member.

16. A method as recited in claim 9, in which the step of providing the brace assembly comprises the steps of:
providing a brace rod configured to extend through the drive member, the bushing assembly, the retaining sleeve, and the bushing opening;
providing an anchor nut configured to engage brace rod and the structural member; and
providing a brace nut configured to engage brace rod and the actuator housing assembly such that the brace assembly maintains a maximum distance between the actuator housing assembly and the structural member; whereby
engaging the brace rod with the anchor nut and the brace nut such that the brace assembly limits movement of the actuator housing assembly relative to the structural member.

17. A press tool system for pressing a bushing assembly into a bushing opening defined by a structural member, the press tool system comprising:
a tool assembly comprising a brace assembly, a drive member, and a retaining sleeve; and
an actuator system comprising an actuator housing assembly and a piston member; wherein
the brace assembly is arranged to brace the actuator housing assembly relative to the structural member;
the drive member is arranged between the piston member and the bushing assembly;
the retaining sleeve is arranged at least partly around the bushing assembly;
the retaining sleeve is arranged and configured to engage the structural member as the bushing assembly is forced into the bushing opening; and
the actuator system displaces the piston member relative to the actuator housing assembly to force the bushing assembly at least partly through the retaining sleeve and into the bushing opening in a desired position relative to the structural member.

18. A press tool as recited in claim 17, in which the drive member is arranged and configured to extend at least partly into the retaining sleeve as the bushing assembly is forced into the bushing opening.

19. A press tool as recited in claim 17, in which the brace assembly comprises:
a brace rod configured to extend through the drive member, the bushing assembly, the retaining sleeve, and the bushing opening;
an anchor nut configured to engage brace rod and the structural member; and
a brace nut configured to engage brace rod and the actuator housing assembly such that the brace assembly maintains a maximum distance between the actuator housing assembly and the structural member; whereby
the brace assembly is arranged and configured to limit movement of the actuator housing assembly relative to the structural member.
